(19) United States
(12) Patent Application Publication
(10) Pub. No.: US 2003/0160889 A1
(43) Pub. Date: Aug. 28, 2003

(54) Camera with led lighting source for illuminating a scene to be photographed

(76) Inventor: Gerald Angeli, N. Miami Beach, FL (US)

Correspondence Address: Kerry Sisselman, Concord Camera Corp., Suite 650N, 4000 Hollywood Blvd., Hollywood, FL, 33021, US

(21) Appl. No.: 10/081,143

(22) Filed: Feb. 22, 2002

(51) Int. Cl. H04N 5/235

(52) U.S. Cl. 348/362

(57) ABSTRACT

An external lighting source for a camera is provided. A visible spectrum light emitting diode, such as a white LED is used instead of the conventional gas tube flash mechanism of a camera to bathe a scene in bright visible light. A reflector directs the light from the LED outward from the camera to illuminate a scene in a fairly uniform manner during the image capture period.

### FIELD OF THE INVENTION

The present invention relates to the field of cameras, and more particularly, to a camera flash device wherein the external lighting source comes from light emitting diodes.

### BACKGROUND OF THE INVENTION

Cameras including infrared emitting diodes are known. U. S. Pat. No. 4,866,285 to Simms discloses an infrared flash unit for use with a camera employing infrared film. The '285 patent describes a flash unit having a front panel with an array of eight individual reflectors, each containing an infrared emitting diode. U.S. Pat. No. 6,275,256 to Olczak, et al., discloses a digital camera illuminator including a body of transparent material defining a cone shaped cavity with an opening at the apex of the cone for a taking lens of the camera and an opening at the base of the cone for locating an object to be photographed with the digital camera. A plurality of infrared emitting diodes are uniformly distributed throughout the body of transparent material.

Additionally, it is known to use laser generators and/or laser diodes to project a visible frame profile to assist in framing a photograph. U.S. Pat. No. 5,589,905 to McIntyre discloses a camera including a visible light framing emitter that produces a scanned visible beam of light which outlines a portion of the ambient scene to be recorded and appears, for example, as a readily visible red rectangular frame on the scene. The framing aid emitter is deactivated when the image capture mechanism of the camera is active. U.S. Pat. No. 6,178,297 to Ting discloses a camera with laser view framing function. When a switch key is pressed, the laser generator is actuated to emit a laser beam, which passes through the frame profile hole of the shade to form a profile light frame framing an area of which a user is taking a picture. Both cameras disclosed in the '297 and '905 patents include separate flash components in addition to the laser generator/laser diode profile generators.

What is needed is a camera including an LED light source that bathes a scene to be photographed with visible light.

This and other objects and advantages of the present invention will become more readily apparent in the description that follows.

### SUMMARY OF THE INVENTION

What is provided is a lighting source for a camera that is particularly useful under low ambient lighting conditions at close range. A visible spectrum light emitting diode, such as a white LED, is provided in a camera, instead of the conventional gas tube flash mechanism. A reflector housed in the front of the camera directs the light from the LED toward the scene to be captured in order to bathe the scene in bright visible light during image capture. A simple circuit for operating the LED is provided. As such, no complicated Dashboards containing expensive capacitors are required.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings an exemplary embodiment that is presently preferred, it being understood, however, that the invention is not limited to the specific methods and instrumentality's disclosed. In the drawings:

FIG. 1 is a front perspective view of a camera including the LED lighting source of one embodiment of the present invention.

FIG. 2 is a simplified front plan view of an internal portion of a camera including an LED lighting source in accordance with one embodiment of the present invention.

FIG. 3 is a front perspective view of a camera including an LED lighting source in accordance with another embodiment of the present invention.

FIG. 4 is a front perspective cutaway view of a camera including an LED lighting source in accordance with the embodiment of FIG. 3.

FIG. 5 is a front perspective cutaway view of a camera including an LED lighting source in accordance with another embodiment of the present invention.

FIG. 6 is a front perspective view of a camera in accordance with another embodiment of the present invention.

### DETAILED DESCRIPTION OF THE PREFERRED EMBODIMENTS

Before explaining the disclosed embodiment of the present invention in detail, it is to be understood that the invention is not limited in its application to the details of the particular arrangement shown since the invention is capable of other embodiments. Also, the terminology used herein is for the purpose of description and not of limitation.

A camera is provided including as its external communication source a visible spectrum light emitting diode (LED) to fairly uniformly bathe a scene to be photographed in direct visible light from the LED. The LED of the present invention is provided instead of a camera's conventional gas tube flash having a charged capacitor trigger circuit.

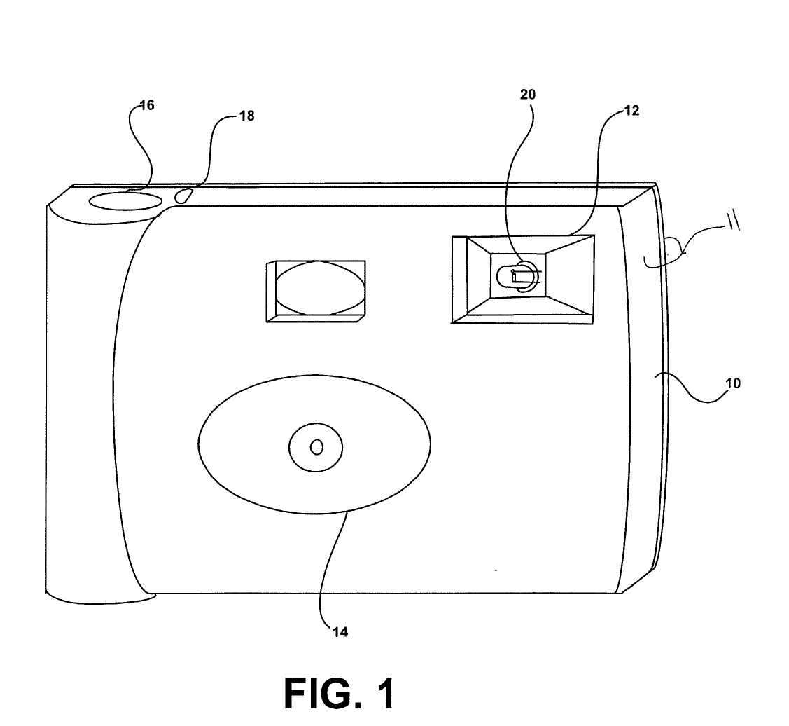

Referring now to FIG. 1, there is shown a camera 10 in accordance with one embodiment of the present invention. The camera 10 includes an outer housing 11. Additionally, a focusing reflector 12, a taking lens 14, the trigger button 16 and an exposure indicator 18 for indicating the pictures remaining in the unexposed film roll are included in camera 10. A bright visible light emitting diode (LED) 20 is placed in the focusing reflector 12, preferably in the center. In the present embodiments, a white visible light emitting diode is most preferred. White LEDs emit bright white light in the visible spectrum when powered and have been found to last about 100,000 hours of continuous use. A white LED acts as a very bright point source for illumination, making the present invention particularly well suited for taking pictures at close range.

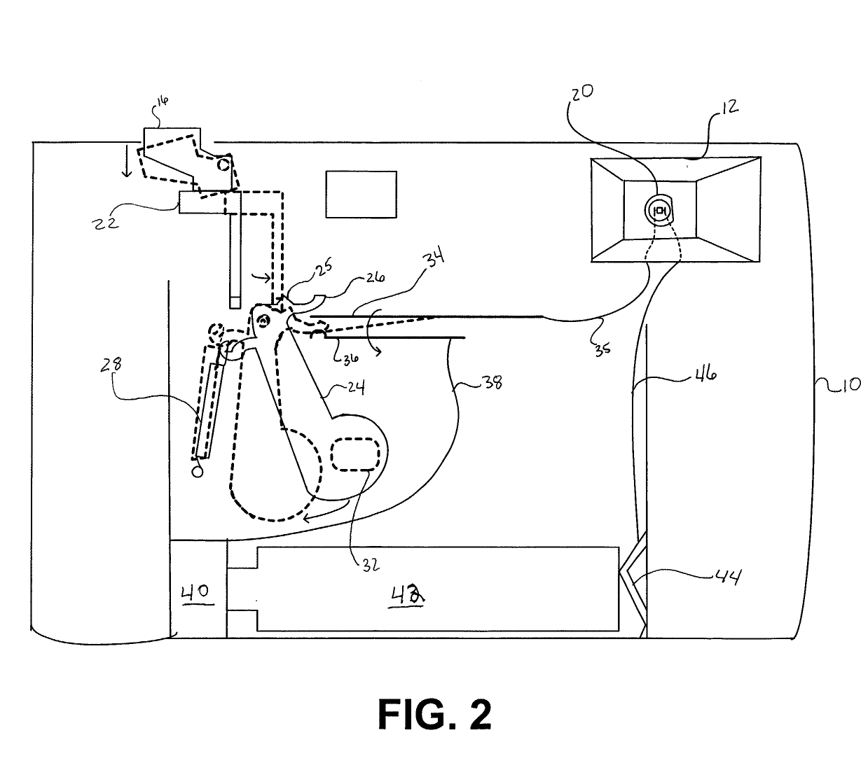

Referring now to FIG. 2, there is shown a simplified view of the front inside portion of the camera 10 made in accordance with one embodiment of the present invention. In the present embodiment, the operation of the white LED 10 is activated for the duration of the shutter operation.

More specifically, advancing the film using a winding wheel (not shown) cocks a striker 22 (shown in the cocked position in solid). When cocked, the striker 22 is spring loaded by a torsion spring (not shown). Taking a picture by pressing the shutter trigger 16 moves the striker 22, causing the torsion spring to drive the striker 22 across a spur 25 on the shutter blade 24. The striker 22 remains on the other side of the spur 25 until the striker 22 is again cocked by winding the film. When passing over the spur 25, the striker 22 causes the shutter blade 24 to swing, exposing the shutter aperture 32 for an instant (1/30^{th} of a second to 1/60^{th} of a second) to expose the film.

Additionally, striking the spur 25 rotates the shutter blade 24 (as shown in shadow) on the pivot pin 25 and extends the coil spring 28. As soon as the striker 22 passes over the spur 25, the coil spring 28 returns to its rest position, pivoting the shutter blade 24 back over the exposure aperture 32.

The shutter blade 24 additionally includes a switch arm 26. As the striker 22 passes over the spur 25, pivoting the shutter blade 24, the switch arm 26 biases a spring contact 34 against the spring contact 36, closing the circuit. The spring contacts 34, 36 remain closed while the exposure aperture 24 is exposed. Note that changing the length of the spring contact 34 and/or the angle of the arm 26 can adjust the length of time the spring contacts 34, 36 are closed.

Additionally, the camera 10 includes electrodes 40 and 44 in contact with the anode and cathode of a battery 42, respectively. A white LED has a voltage drop of 3.6 volts. As such, the battery 42 should be chosen so as to adequately power the LED. Additionally, a current limiting resistor may optionally be added to the circuit.

The anode electrode 40 is connected to the spring contact 36 by a wire 38. The spring contact 34 is connected to the positive terminal of the LED 20 by a wire 35. Similarly, the cathode electrode 44 is connected to the negative terminal of the LED 20, by the wire 46. When the two spring contacts are closed, the battery 42 lights the LED 20 during the image capture period.

In operation, illumination of the LED is timed with the movement of the shutter blade 24, through the current specific design of the shutter blade 24 and arm 26. When the shutter blade 24 swings open, the arm 26 closes the contacts 34, 36 bathing the scene in bright white visible light from the LED 20. As the shutter blade 24 returns to cover the exposure aperture 32, the arm 26 lifts from the spring contact 34, permitting the spring contact to return to its rest position and, thus, turning off the LED 20.

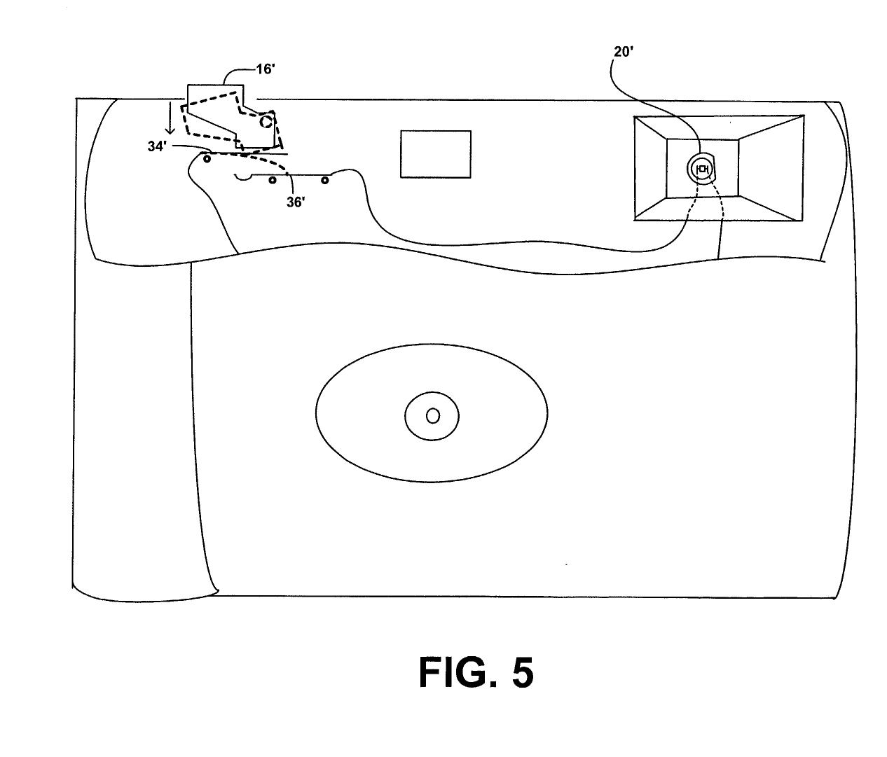

Note that this is not meant to be limiting, other means may be used to close the spring contacts 34, 36. For example, referring now to FIG. 5, there is shown another embodiment of the present invention wherein the spring contacts 34′, 36′ are located proximal to the trigger 16′, such that depression of the trigger directly closes the spring contacts 34′, 36′, lighting the LED 20′. As can be seen, the LED of the present embodiment will remain lit so long as the trigger 16′ is pressed. This differs from the previous embodiment wherein depression of the trigger 16 indirectly actuates the LED by setting the striker in motion, and wherein the pivoting of the shutter blade 24 controls the length of time the LED is lit.

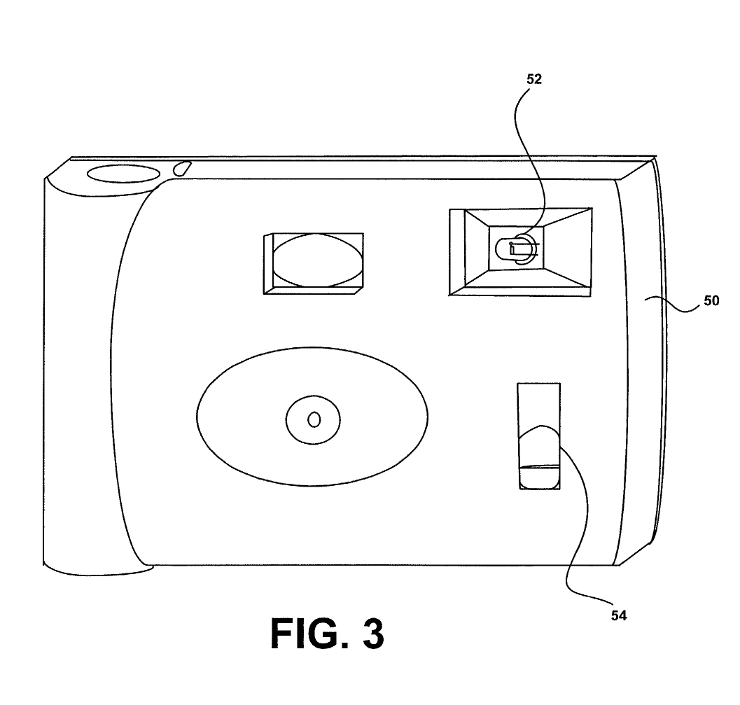

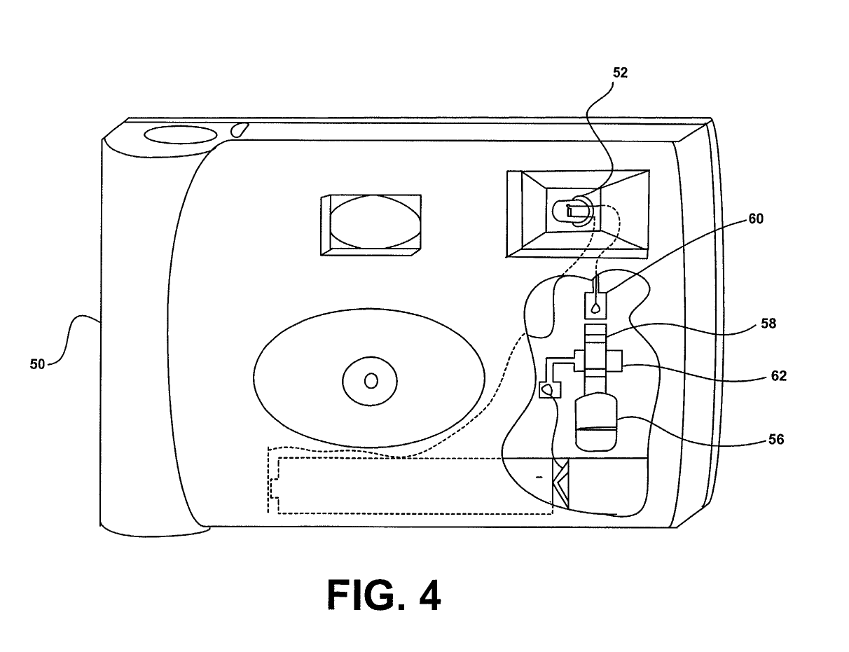

Referring now to FIGS. 3 and 4 there is shown another embodiment of a camera 50 made in accordance with the present invention. The camera 50 includes a light focusing reflector 52 having LED 52 centered therein. In the present embodiment, rather than synchronizing the flash with the opening of the exposure aperture, a switch 54 is provided to turn on the LED 52. In the present preferred embodiment, the external switch plate 56 is attached to a sliding metal contact 58. The anode of the battery 64 is connected to the positive terminal of the LED 52. The cathode of the battery 64 is connected to the negative terminal of the LED 52 via the contact pads 60 and 62, and the sliding metal contact 58, when the switch 54 is closed. Note that, again a battery 64 must be chosen sufficient to power the LED.

In operation, the user slides the external switch plate 56 from a first open position to a second closed position. This slides the sliding metal contact 58 into position to conduct across the gap between the switch electrode pads 60 and 62 and completes the circuit, turning on the LED 52. After the picture(s) has/have been taken, the user may slide the external switch plate 56 back to the first position, breaking the connection between the electrodes 60, 62 and turning off the LED 52. Optionally, additional circuitry may be provided to strobe the LED 52 while the switch 54 and LED 52 are on.

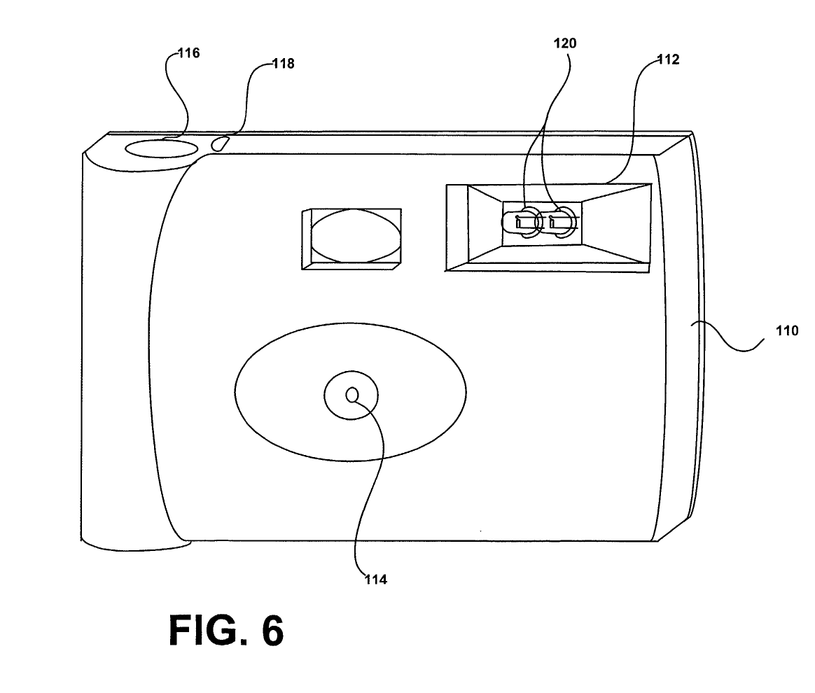

Referring now to FIG. 6, there is shown another embodiment of the present invention using a plurality of LEDs 120 provided in series. The operation of the LED lighting source of the embodiment of FIG. 5 may be similar to those explained in connection with the embodiments of FIGS. 1-4. However, a battery or multiple batteries that can accommodate a plurality of 3.6 volt drops must be provided. Additionally, although two LEDs are shown in the preferred embodiment of FIG. 6, more LEDs may be provided, if desired.

While the invention has been described with reference to a preferred embodiment, it will be understood by those skilled in the art that various changes may be made and equivalents may be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A camera comprising:
a camera housing;
a shutter trigger, a portion of which extends through said camera housing;
a film exposure aperture opened by depressing said shutter trigger;
a reflector in said camera housing and visible there through;
a visible light LED arranged in said reflector to bathe a scene to be photographed fairly uniformly in visible light;
a power source contained within said camera housing; and
a switch connected between said power source and said visible light LED for turning on said visible light LED when said switch is closed.

2. The camera of claim 1, wherein said visible light LED is a white light LED.

3. The camera of claim 1, wherein said switch is closed directly by actuation of said shutter trigger.

4. The camera of claim 1, wherein said switch is closed indirectly by actuation of said shutter trigger.

5. The camera of claim 3, wherein said switch is closed by physical contact with said trigger when said trigger is pressed.

6. The camera of claim 5, wherein said switch is closed while said exposure aperture is open.

7. The camera of claim 6, additionally including an opaque shutter blade located at rest over said exposure aperture, said opaque shutter blade in communication with said shutter trigger such that pressing said shutter trigger causes said shutter blade to pivot, which opens said exposure aperture, and wherein said pivoting opaque shutter blade closes said switch.

8. The camera of claim 1, wherein said switch includes a sliding switch member, a portion of said sliding switch member extending through said housing, said sliding switch member slideable between a first position wherein said switch is open and a second position wherein said switch is closed.

10. The camera of claim 9, wherein said LED remains on when said sliding switch member is in said second position until said sliding switch member is manually returned to said first position.

11. The camera of claim 1, additionally including at least a second LED.

12. The camera of claim 11, wherein said at least a second LED is connected in series with said visible light LED.

13. A method for taking a picture in a low ambient light situation, comprising the steps of:
providing a camera including:
a camera housing;
a shutter trigger, a portion of which extends through said camera housing;
a film exposure aperture opened by pressing said shutter trigger;
a visible light LED contained inside said camera housing and visible therethrough, said visible light LED arranged to bathe a scene to be photographed fairly uniformly in visible light;
a power source contained within said camera housing; and
a switch connected between said power source and said visible light LED for turning on said visible light LED when said switch is closed;
closing said switch to illuminate said visible light LED;
pressing said shutter trigger to open said film exposure aperture; and
opening said switch to turn off said visible light LED.

14. The method of claim 13, wherein said visible light LED includes at least one white LED.

15. The method of claim 14, wherein said closing step is performed prior to said pressing step.

16. The method of claim 14, wherein said closing step is performed as a result of said pressing step.

17. The method of claim 16, wherein said shutter trigger directly closes said switch and wherein said switch remains closed so long as said shutter trigger is pressed.

18. The method of claim 16, wherein said camera additionally includes an opaque shutter blade located at rest over said exposure aperture, said opaque shutter blade in communication with said shutter trigger such that depression of said shutter trigger causes said shutter blade to pivot, opening said exposure aperture, and wherein said pivoting opaque shutter blade closes said switch while said exposure aperture is open.

19. A camera comprising:
a camera housing;
a shutter trigger, a portion of which extends through said camera housing;
a film exposure aperture opened by depressing said shutter trigger;
a white LED arranged in said reflector to bathe a scene to be photographed fairly uniformly in visible white light;
a power source contained within said camera housing; and
a switch connected between said power source and said white LED for turning on said white LED when said switch is closed.

20. The camera of claim 19, wherein said white LED is illuminated in response to pressing said shutter trigger.
